(19) United States
(12) Patent Application Publication
(10) Pub. No.: US 2022/0383283 A1
(43) Pub. Date: Dec. 1, 2022

(54) SYSTEMS AND METHODS FOR RULES MANAGEMENT FOR A DATA PROCESSING NETWORK

(71) Applicant: MASTERCARD INTERNATIONAL INCORPORATED, Purchase, NY (US)

(72) Inventor: Gowri Shankar Rangaswamy, Dardenne Prairie, MO (US)

(21) Appl. No.: 17/332,039

(22) Filed: May 27, 2021

(51) Int. Cl. G06Q 20/14; G06Q 20/40; G06N 20/00

(52) U.S. Cl. CPC G06Q 20/14; G06Q 20/405; G06N 20/00

(57) ABSTRACT

A rules management (RM) computing device may be provided. The RM computing device may include at least one processor configured to retrieve, from a rules database, a plurality of rules, each of the plurality of rules including one or more data elements that generate an output value based on an input value, generate, for each of the plurality of rules, one or more tags based on the one or more data elements, store the generated tags in the rules database in association with the plurality of rules, receive, from a first user computing device, a proposed modification for a target rule of the plurality of rules, parse the rules database to identify related rules based on the one or more tags associated with the target rule, and cause to be displayed, on the first user computing device the identified related rules.

### BACKGROUND

This disclosure relates generally to data management, and more specifically, to network-based systems and methods for rules management for a data processing network.

Computing devices use rules to generate output values based on input values. In a computer system, such as a data processing network, thousands or more of such rules may be used to generated outputs based on, for example, a high volume of inputs, which may be of various types and forms. For example, in a bill processing network, various billing activities (e.g., transactions or other activity for which a customer may be billed) may be analyzed using billing rules to generate invoices. As the number of rules in such a system increases, the complexity of modifying and keeping track of the rules increases as well. For example, to implement a change for a data processing network (e.g., to achieve a desired output for a given input), many of the rules used by the network may require modification. Manual modification of rules in the network may therefore result an insubstantial delay in the implementation of changes to the network, and may result in sub-optimal usage of database storage and computing power resources.

A system that provides automated rules management capability for a data processing network is therefore desirable.

### BRIEF DESCRIPTION

In one aspect, a rules management (RM) computing device may be provided. The RM computing device may include at least one processor in communication with at least one memory device and a rules database. The at least one processor may be configured to retrieve, from the rules database, a plurality of rules, each of the plurality of rules including one or more data elements that generate an output value based on an input value. The at least one processor may further be configured to generate, for each of the plurality of rules, one or more tags based on the one or more data elements. The at least one processor may further be configured to store the generated tags in the rules database in association with the plurality of rules. The at least one processor may further be configured to receive, from a first user computing device, a proposed modification for a target rule of the plurality of rules. The at least one processor may further be configured to parse the rules database to identify related rules based on the one or more tags associated with the target rule. The at least one processor may further be configured to cause to be displayed, on the first user computing device the identified related rules.

In another aspect, a computer-implemented method for rules management may be provided. The computer-implemented method may be performed by a rules management (RM) computing device including at least one processor in communication with at least one memory device and a rules database. The computer-implemented method may include retrieving, by the RM computing device, from the rules database, a plurality of rules, each of the plurality of rules including one or more data elements that generate an output value based on an input value. The computer-implemented method may further include generating, by the RM computing device, for each of the plurality of rules, one or more tags based on the one or more data elements. The computer-implemented method may further include storing, by the RM computing device, the generated tags in the rules database in association with the plurality of rules. The computer-implemented method may further include receiving, by the RM computing device, from a first user computing device, a proposed modification for a target rule of the plurality of rules. The computer-implemented method may further include parsing, by the RM computing device, the rules database to identify related rules based on the one or more tags associated with the target rule. The computer-implemented method may further include causing, by the RM computing device, to be displayed, on the first user computing device, the identified related rules.

In another aspect, at least non-transitory computer-readable media having computer-executable instructions embodied thereon may be provided. When executed by a rules management (RM) computing device including at least one processor in communication with at least one memory device and a rules database, the computer-executable instructions may cause the at least one processor to retrieve, from the rules database, a plurality of rules, each of the plurality of rules including one or more data elements that generate an output value based on an input value. The computer-executable instructions may further cause the at least one processor to generate, for each of the plurality of rules, one or more tags based on the one or more data elements. The computer-executable instructions may further cause the at least one processor to store the generated tags in the rules database in association with the plurality of rules. The computer-executable instructions may further cause the at least one processor to receive, from a first user computing device, a proposed modification for a target rule of the plurality of rules. The computer-executable instructions may further cause the at least one processor to parse the rules database to identify related rules based on the one or more tags associated with the target rule. The computer-executable instructions may further cause the at least one processor to causing to be displayed, on the first user computing device the identified related rules.

### BRIEF DESCRIPTION OF THE DRAWINGS

FIGS. 1-12 show example embodiments of the methods and systems described herein.

FIG. 1 is a schematic diagram illustrating an exemplary rules management (RM) system according to one example embodiment of the present disclosure.

FIG. 2 is a data flow diagram illustrating an exemplary data flow within the RM system illustrated in FIG. 1 according to one example embodiment of the present disclosure.

FIG. 3 is an example configuration of a client system, according to one example embodiment of the present disclosure.

FIG. 4 illustrates an example configuration of a server system, according to one example embodiment of the present disclosure.

FIG. 5 illustrates an example configuration of a RM computing device shown in FIG. 1, according to one example embodiment of the present disclosure.

FIG. 6 is a flowchart of a computer-implemented method for rules management, which may be implemented using the system shown in FIG. 1.

FIG. 7 is a continuation of the flowchart shown in FIG. 6.

FIG. 8 is a continuation of the flowchart shown in FIG. 7.

FIG. 9 is a flowchart of a computer-implemented method for rules management, which may be implemented using the system shown in FIG. 1.

FIG. 10 is a schematic illustration of a screenshot of a user interface that may be used in the RM system shown in FIG. 1, according to one example embodiment of the present disclosure.

FIG. 11 is a schematic illustration of another screen of the user interface of FIG. 10 that may be used in the RM system shown in FIG. 1, according to one example embodiment of the present disclosure.

FIG. 12 is a schematic illustration of another screen of the user interface of FIG. 10 that may be used in the RM system shown in FIG. 1, according to one example embodiment of the present disclosure.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure describes example embodiments, namely, systems and methods for utilizing a rules management (RM) computing device as described in detail herein. The RM computing device may be in communication with, for example, a rules database, one or more user computing devices, and/or other computing devices.

In some example embodiments, the RM computing device may receive a proposed modification for a target rule stored in the rules database. The target rule may be one of a plurality of rules (e.g., billing rules) stored in the rules database that may be executed by a data processing network (e.g., a bill processing network) to generate an output (e.g., an invoice) based on an input (e.g., transaction activity and the like). The RM computing device may identify other rules stored in the rules database to modify based on the proposed modification (e.g., for to achieve sematic consistency across the plurality of rules). The RM computing device may further display the identified rules to a user, generate suggested modifications to the identified rules, and/or automatically modify the identified rules. The RM computing device may further provide an interface through which a plurality of users at a plurality of corresponding user computing devices may review and test proposed rules before the rules are built and implemented in the data processing system.

The RM computing device includes a processor in communication with a memory. The RM computing device may be in communication with at least one database (e.g., the rules database) for storing information. The RM computing device may further be in communication with one of more user computing devices, which may provide an interface through which users can interact with the RM computing device.

In the example embodiment, the RM computing device may be configured to retrieve, from the rules database, a plurality of rules, each of the plurality of rules including one or more data elements that generate an output value based on an input value. For example, in some embodiments, the rules may be applied (e.g., using a data processing network) to an input value having a plurality of data fields, each including a data value. The rule, when executed, may generate the output value based on the data fields and data values of the input value.

For example, in some embodiments, the rules may be billing rules, and the input values may be billing events (e.g., transactions or other activities for which a customer may be charged fees). In such embodiments, the data fields of the billing event may include items delivered, time worked, milestones reached, corresponding prices and discounts, geographic location, and other factors on which a billed amount for a customer may be calculated. As used herein, a customer may refer to a person or entity receiving a product or service from another party. For example, in the case of the systems and methods described herein, a customer may be a person or entity receiving billing services from another party such as a merchant, an acquirer, or an issuer, who may receive services from a processing network for billing services provided for processing payment card transactions. Accordingly, billing rules may generate an invoice amount to be billed to the customer based on the input billing event. In some such embodiments, each rule may have (e.g., be stored in association with) an effective date or range of effective dates, during which the rules may be executed by the data processing network.

In some embodiments, the rules may be stored in the rules database (e.g., by the RM computing device) according to a hierarchy and/or another organizational scheme. For example, the rules database may include a number of data units referred to herein as pointers, and each of the rules may be associated with one of the pointers in the database. Further, each rule may include one or more rule segments into which the data elements of the rule may be divided. Each of the pointers, rules, and rule segments may be associated with corresponding identifiers (e.g., a pointer identifier, a rule identifier, or a segment identifier) in the database. The identifiers may be, for example, a number, an alphanumeric code, or another unique data feature. As described below, this data structure of the rules database may be used by the RM computing device to identify relationships between rules.

In the example embodiment, the RM computing device may further be configured to generate, for each of the plurality of rules, one or more tags based on the one or more terms. For example, the tags may be generated based on the data elements of the rule and/or data fields of a billing event associated with the rule (e.g., a billing event for which the rule would be used to determine an invoice amount). In some embodiments, the tags may include, or be generated based on, one or more of the identifiers associated with the pointer, rule, or rule segment. The RM computing device may further be configured to store the generated tags in the rules database in association with the plurality of rules.

In some embodiments, the RM computing device may receive a request to modify a rule (e.g., the target rule) from the user computing device. In response to the request, the RM computing device may retrieve, the target rule from the rules database, transmit the retrieved target rule to the user computing device, and flag the target rule in the database as checked out in response to transmitting the target rule. Other users may be prevented from modifying the rule while the rule is flagged as checked out. Once the proposed modification of the target rule is resubmitted via the RM computing device, the RM computing device may flag the target rule in the database as checked in in response to receiving the proposed modification.

In the example embodiment, the RM computing device may receive (e.g., from the user computing device) the proposed modification for a target rule of the plurality of rules. The RM computing device may display the proposed modification at additional user computing devices, so that other users may review the proposed modification (e.g., for quality assurance prior to implementing the rule). These additional user computer devices are in network communication with the first user computing device and the RM computing device. For example, in some embodiments, the RM computing device may enable the proposed modification to the target rule to be tested before a finalized modified target rule is built by the RM computing device and stored in the rules database.

In the example embodiment, the RM computing device may further be configured to parse the database to identify related rules based on the one or more tags associated with the target rule. For example, the RM computing device may compare tags associated with the target rule to tags associated with other rules in the rules database, and identify rules associated with matching tags as rules related to the target rule. The RM computing device may further be configured to display the identified related rules at the user computing device.

In some embodiments, the RM computing device may generate, for at least some of the related rules, a suggested modification based on the proposed modification. For example, the RM computing device may compare data values, data fields, or other data elements associated with the target rule to other rules (e.g., the related rules) in the database. Additionally or alternatively, the RM computing device may utilize artificial intelligence and/or machine learning techniques to generate suggested modifications. As with the initial proposed modification, in some embodiments, the RM computing device may display the suggested modification at additional user computing devices, for example, for review, testing, or approval of the suggested modifications. In some embodiments, the RM computing device may enable review and testing of submitted modifications. For example, the RM computing device may enable new or modified rules to be tested by simulating transactions based on transaction data stored in a dedicated simulation database, applying the new or modified rules to the simulated transactions, and evaluating the results of the new or modified rules. The RM computing device may further automatically build updated related rules (sometimes referred to herein as “modified related rules”) based on the suggested modification. The RM computing device may store the modified related rules in the rules database.

The technical problems addressed by the disclosure include at least one of: (i) inability of a computing device to identify, based on a proposed modification to a target rule in a data processing network, additional rules in the data processing network to modify; (ii) inability of a computing device to generate a suggested modification for one or more rules in a data processing network based on a proposed modification to a target rule; (iii) inability of a computing device to automatically modify rules in a data processing network based on a proposed modification to a target rule; (iv) inefficient data storage of a database for a data processing network; and/or (v) inability of a computing device to automatically modify rules in a data processing network to increased computing efficiency of the data processing network.

The technical effects achieved by the systems and methods described herein include at least one of: (i) retrieving, from the rules database, a plurality of rules, each of the plurality of rules including one or more data elements that generate an output value based on an input value; (ii) generating, for each of the plurality of rules, one or more tags based on the one or more data elements; (iii) storing the generated tags in the rules database in association with the plurality of rules; (iv) receiving, from a first user computing device, a proposed modification for a target rule of the plurality of rules; (v) parsing the rules database to identify related rules based on the one or more tags associated with the target rule; and/or (vi) displaying, at the first user computing device the identified related rules.

The resulting technical benefits achieved by the systems and methods of the disclosure include at least one of: (i) a data structure that enables a computing device to identify, based on a proposed modification to a target rule in a data processing network, additional rules in the data processing network to modify; (ii) a data structure that enables a computing device to generate a suggested modification for one or more rules in a data processing network based on a proposed modification to a target rule; (iii) a data structure that enables a computing device to automatically modify rules in a data processing network based on a proposed modification to a target rule; (iv) a data structure that increases data storage efficiency of a database for a data processing network; (v) a data structure that enables a computing device to automatically modify rules in a data processing network to increased computing efficiency of the data processing network; (vi) improved efficiency in updating rules and bringing the system back online during the rule updating process; and/or (vii) reducing errors and reducing or improving bandwidth by identifying all rules that need to be modified.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

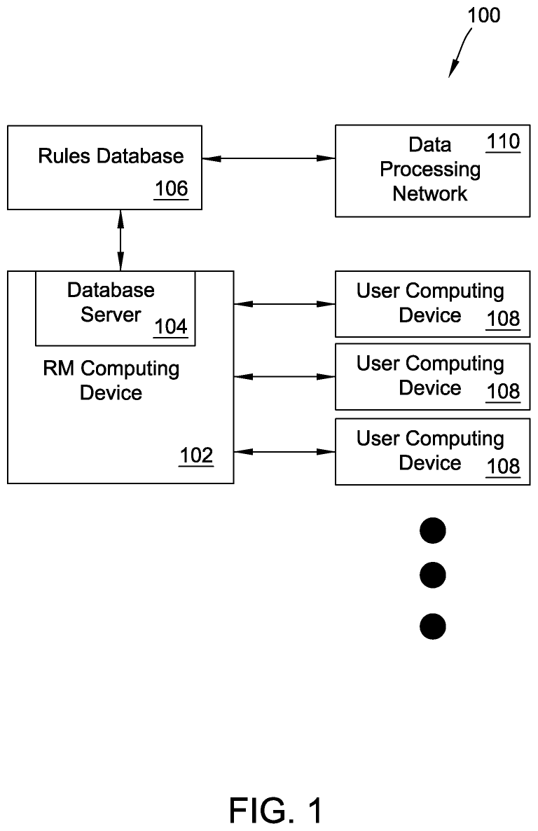

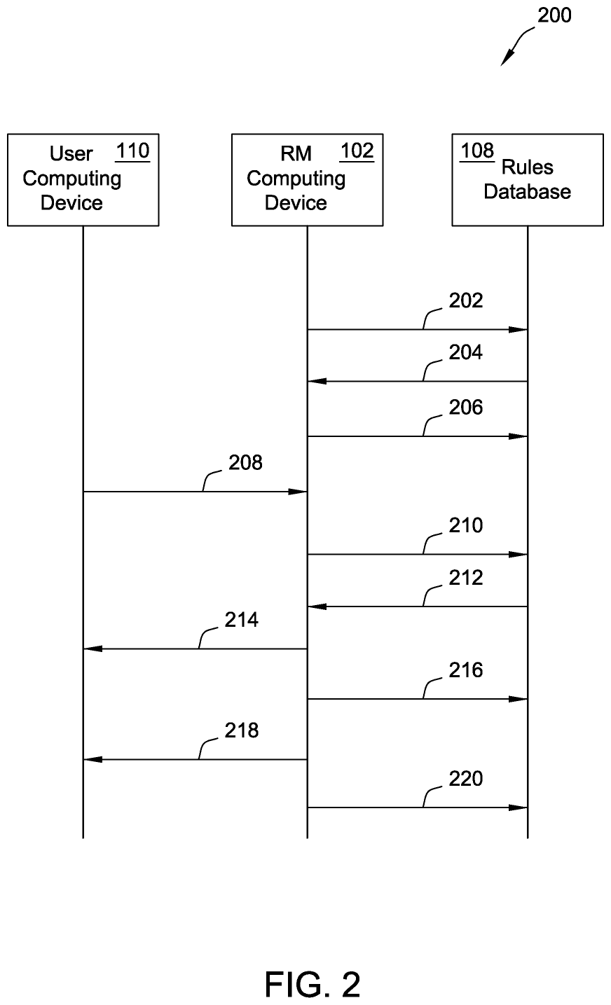

FIG. 1 is a simplified block diagram of an exemplary rules management (RM) system 100 in accordance with one example embodiment of the present disclosure. FIG. 2 is a data flow diagram of an exemplary data flow 200 within RM system 100. RM system 100 includes an RM computing device 102 that includes at least one database server 104. RM system 100 may further include a rules database 106, one or more user computing devices 108 (e.g., a workstation, personal computer, tablet computer, and/or mobile telephone), and/or a data processing network 110 (e.g., a bill processing network).

RM computing device 102 may include at least one processor in communication with at least one memory device. RM computing device may be in communication with rules database 106 via database server 104. RM computing device may further be in communication with one or more user computing devices 108.

Rules database 106 may be in communication with data processing network 110 and may store rules 202 (e.g., from RM computing device 102). Rules 202 may include one or more data elements (e.g., code) that may be used by data processing network 110 to generate an output value based on an input value. For example, in some embodiments, rules 202 may be billing rules, and data processing network 110 may generate invoices based on billing events (e.g., transactions or other activities for which a customer may be charged fees) using rules 202.

In the example embodiment, RM computing device 102 may be configured to retrieve 204, from rules database 106, a plurality of rules 202, each of the plurality of rules 202 including one or more data elements that generate an output value based on an input value. For example, in some embodiments, each rule 202 may be applied (e.g., using data processing network 110) to an input value having a plurality of data fields, each including a data value. Rule 202, when executed, may generate the output value based on the data fields and data values of the input value.

For example, in some embodiments, each rule 202 may be a billing rule, and the input values may be billing events (e.g., transactions or other activities for which a customer may be charged fees). In such embodiments, the data fields of the billing event may include items delivered, time worked, milestones reached, corresponding prices and discounts, geographic location, and other factors on which a billed amount for a customer may be calculated. A customer may be a person or entity receiving a product or service from another party. For example, a customer may be a person or entity receiving billing services from another party such as a merchant, an acquirer, or an issuer, who may receive services from a processing network for billing services provided for processing payment card transactions. Accordingly, billing rules may generate an invoice amount to be billed to the customer based on the input billing event. In some such embodiments, each rule 202 may have (e.g., be stored in association with) an effective date or range of effective dates, during which each rule 202 may be executed by data processing network 110.

In some embodiments, each rule 202 may be stored in rules database 106 (e.g., by RM computing device 102) according to a hierarchy and/or another organizational scheme. For example, rules database 106 may include a number of data units referred to herein as pointers, and each of the rules may be associated with one of the pointers in the database. Further, each rule may include one or more rule segments into which the data elements of the rule may be divided. Each of the pointers, rules, and rule segments may be associated with corresponding identifiers (e.g., a pointer identifier, a rule identifier, or a segment identifier) in the database. The identifiers may be, for example, a number, an alphanumeric code, or another unique data feature. As described below, this data structure of rules database 106 may be used by RM computing device 102 to identify relationships between rules.

In the example embodiment, RM computing device 102 may further be configured to generate, for each of the plurality of rules, one or more tags 206 based on the one or more terms. For example, tags 206 may be generated based on the data elements of the rule and/or data fields of a billing event associated with the rule (e.g., a billing event for which the rule would be used to determine an invoice amount). In some embodiments, tags 206 may include, or be generated based on, one or more of the identifiers associated with the pointer, rule, or rule segment. RM computing device 102 may further be configured to store the generated tags 206 in rules database 106 in association with the plurality of rules.

In some embodiments, RM computing device 102 may receive request 208 to modify a rule (e.g., the target rule) from user computing device 108. In response to request 208, RM computing device 102 may retrieve, the target rule from rules database 106, transmit the retrieved target rule to user computing device 108, and flag the target rule in the database as checked out in response to transmitting the target rule. Other users may be prevented from modifying the rule while the rule is flagged as checked out. Once the proposed modification of the target rule is resubmitted via RM computing device 102, RM computing device 102 may flag the target rule in the database as checked in in response to receiving the proposed modification.

In the example embodiment, RM computing device 102 may receive (e.g., from user computing device 108) the proposed modification for a target rule of the plurality of rules. RM computing device 102 may display the proposed modification at additional user computing devices 108, so that other users may review the proposed modification (e.g., for quality assurance prior to implementing the rule). These additional user computer devices 108 are in network communication with first user computing device 108 and RM computing device 102. For example, in some embodiments, RM computing device 102 may enable the proposed modification to the target rule to be tested before a finalized modified target rule 216 is built by RM computing device 102 and stored in rules database 106.

In the example embodiment, RM computing device 102 may further be configured to parse 210 the database to identify related rules 212 based on one or more tags 206 associated with the target rule. For example, RM computing device 102 may compare tags 206 associated with the target rule to tags 206 associated with other rules in rules database 106, and identify rules associated with matching tags 206 as rules related to the target rule. RM computing device 102 may further be configured to display 214 the identified related rules 212 at user computing device 108.

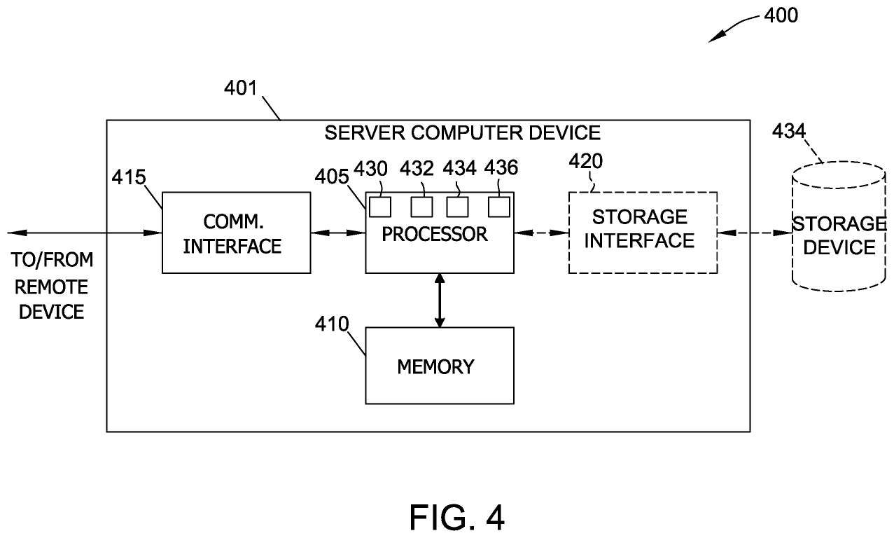

In some embodiments, RM computing device 102 may generate, for at least some related rules 212, a suggested modification 218 based on the proposed modification. For example, RM computing device 102 may compare data values, data fields, or other data elements associated with the target rule to other rules (e.g., related rules 212) in the database. Additionally or alternatively, RM computing device 102 may utilize artificial intelligence and/or machine learning techniques to generate suggested modifications 218. As with the initial proposed modification, in some embodiments, RM computing device 102 may display suggested modification 218 at additional user computing devices 108, for example, for review, testing, or approval of the suggested modifications. In some embodiments, RM computing device 102 may enable the review and testing of submitted modifications. For example, RM computing device 102 may enable new or modified rules to be tested by simulating transactions based on transaction data stored in a dedicated simulation database (maintained for example on storage device 434 shown in FIG. 4), applying the new or modified rules to the simulated transactions, and evaluating the results of the new or modified rules. RM computing device 102 may further automatically build updated modified related rules 220 based on the suggested modification using at least one of machine learning techniques and artificial intelligence techniques. RM computing device 102 may store the modified related rules 220 in rules database 106.

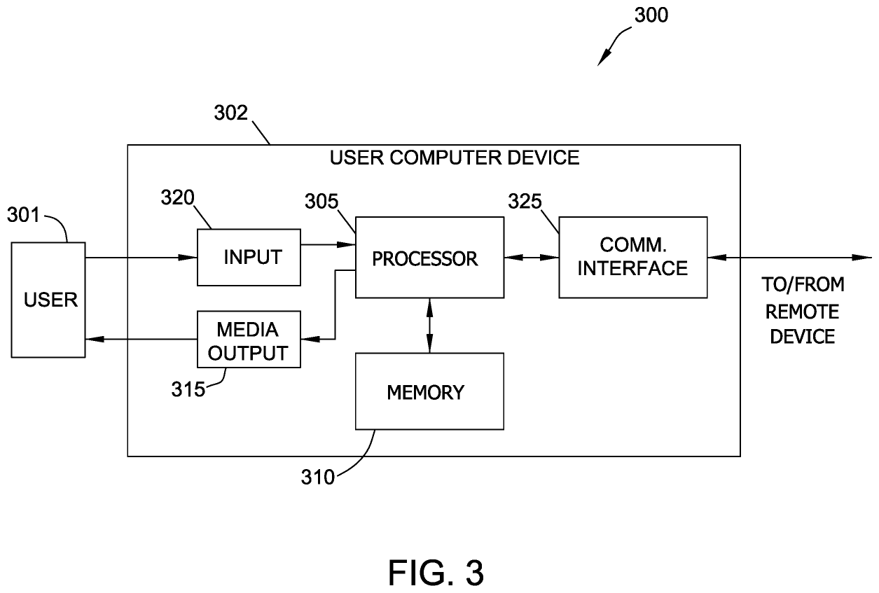

FIG. 3 illustrates an example configuration of a client system 300 in accordance with one embodiment of the present disclosure. In the example embodiment, client system 300 includes at least one user computing device 302, operated by a user 301. User computer device 302 may include, but is not limited to, one or more of RM computing device 102, user computing device 108, and/or data processing network 110 (all shown in FIG. 1). User computer device 302 includes a processor 305 for executing instructions, and a memory area 310. In some embodiments, executable instructions are stored in memory area 310. Processor 305 may, for example, include one or more processing units (e.g., in a multi-core configuration). Memory area 310 may, for example, be any device allowing information such as executable instructions and/or transaction data to be stored and retrieved. Memory area 310 may further include one or more computer readable media.

In the example embodiment, user computer device 302 further includes at least one media output component 315 for presenting information to user 301. Media output component 315 may, for example, be any component capable of converting and conveying electronic information to user 301. For example, media output component 315 may be a display component configured to display component lifecycle data in the form of reports, dashboards, communications, and the like In some embodiments, media output component 315 includes an output adapter (not shown), such as a video adapter and/or an audio adapter, which is operatively coupled to processor 305 and operatively connectable to an output device (also not shown), such as a display device (e.g., a cathode ray tube (CRT), liquid crystal display (LCD), light emitting diode (LED) display, or “electronic ink” display) or an audio output device (e.g., a speaker or headphones).

In some embodiments, media output component 315 is configured to include and present a graphical user interface (not shown), such as a web browser and/or a client application, to user 301. The graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, to access credential information, and/or payment information, to select a target rule, to identify a target rule, to input a modification to a target rule, or to review and accept proposed modifications to a target rule. Input device 320 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component such as a touch screen may function as both an output device of media output component 315 and input device 320. User computing device 302 may also include a communication interface 325, which is communicatively connectable to a remote device such as RM computing device 102 (shown in FIG. 1). Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 are, for example, computer readable instructions for providing a user interface to user 301 via media output component 315 and, optionally, receiving and processing input from input device 320. A user interface may include, among other possibilities, a web browser, and client application. Web browsers enable users, such as user 301, to display and interact with media and other information typically embedded on a web page or a website from a server system. A client application allows user 301 to interact with a server application from the server system (e.g., RM computing device 102). For example, instructions may be stored by a cloud service, and the output of the execution of the instructions sent to the media output component 315.

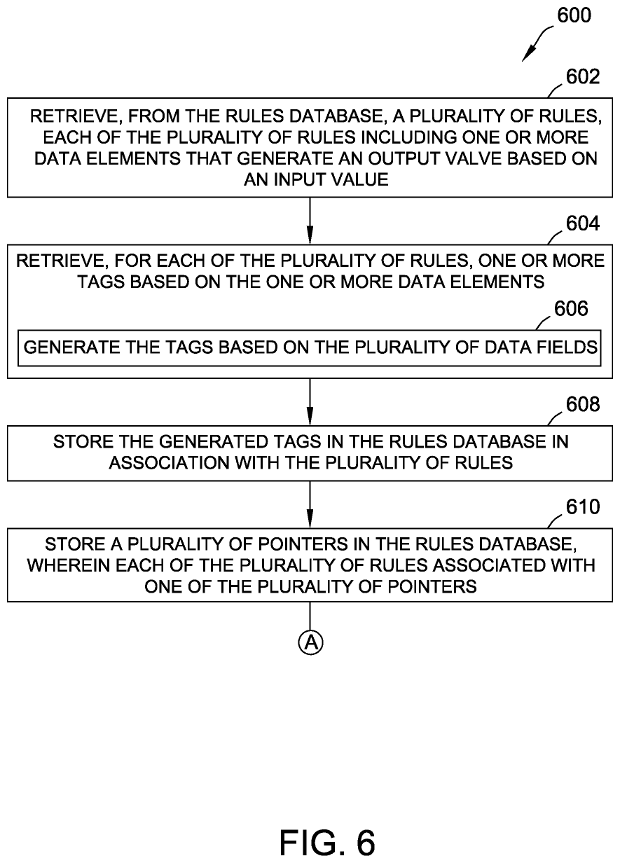

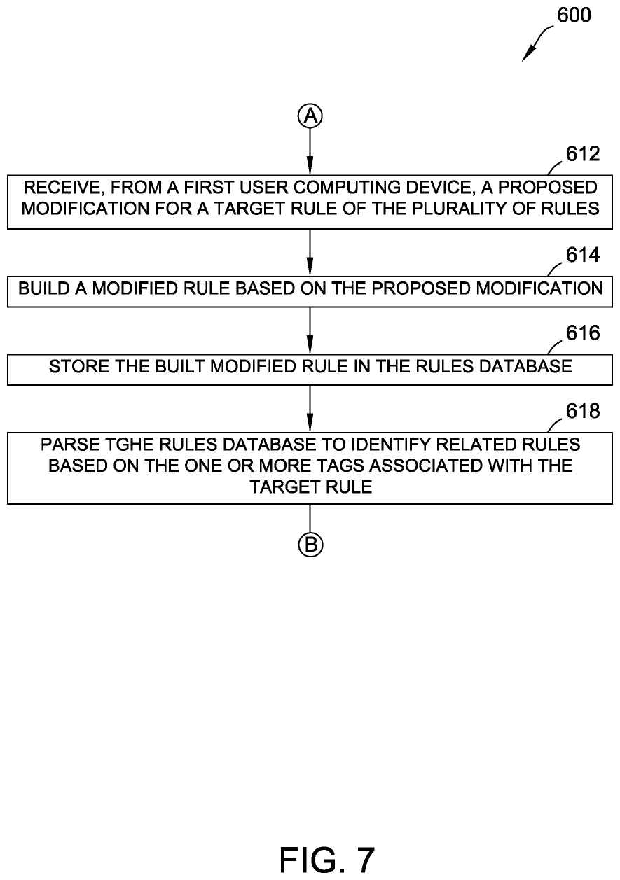

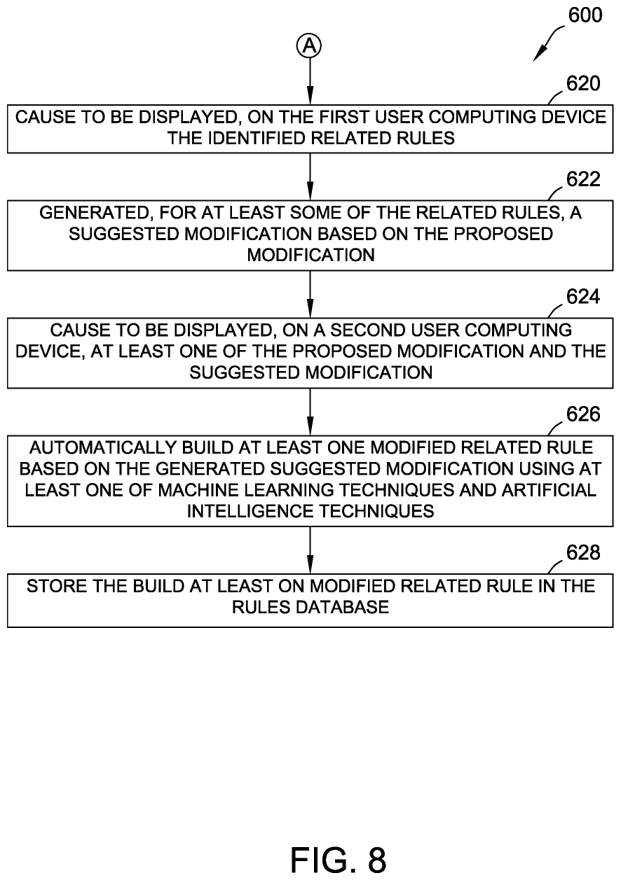

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 may be programmed with instructions such that it may execute the processes as illustrated in FIGS. 6-8, below.

FIG. 4 illustrates an example configuration of a server system 400, such as RM computing device 102 (shown in FIG. 1). In the example embodiment, server system 400 includes at least one server computing device 401, in electronic communication with at least one storage device 417. Server computing device 401 may include, but is not limited to, RM computing device 102. In the exemplary embodiment, server computing device 401 includes a processor 405 for executing instructions (not shown) stored in a memory area 410. In an embodiment, processor 405 may include one or more processing units (e.g., in a multi-core configuration) for executing instructions, for example, to select a target rule, to identify a target rule, to input a modification to a target rule, or to review and accept proposed modifications to a target rule. The instructions may be executed within various different operating systems on the server system 400, such as UNIX®, LINUX® (LINUX is a registered trademark of Linus Torvalds), Microsoft Windows®, etc. More specifically, the instructions may cause various data manipulations on data stored in storage device 417 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In the example embodiment, processor 405 is operatively coupled to a communication interface 415 such that server system 400 is capable of communicating with a remote device such as a user system or another server system 400. For example, communication interface 415 may receive requests from client system 300 (FIG. 3) via the Internet, within the scope of the embodiment illustrated in FIG. 4.

In the example embodiment, processor 405 is also operatively coupled to a storage device 417, which may be, for example, any computer-operated hardware unit suitable for storing and/or retrieving data. In some embodiments, storage device 417 is integrated in server system 400. For example, server system 400 may include one or more hard disk drives as storage device 417. In certain embodiments, storage device 417 is external to server system 400 and is similar to rules database 106 (shown in FIG. 1). For example, server system 400 may include one or more hard disk drives as storage device 417. In other embodiments, storage device 417 is external to server system 400 and may be accessed by a plurality of server systems 400. For example, storage device 417 may include multiple storage units such as hard disks or solid state disks in a redundant array of inexpensive disks (RAID) configuration. Storage device 417 may include a storage area network (SAN) and/or a network attached storage (NAS) system.

In some embodiments, processor 405 is operatively coupled to storage device 417 via a storage interface 420. Storage interface 420 may include, for example, a component capable of providing processor 405 with access to storage device 417. In an exemplary embodiment, storage interface 420 further includes one or more of an Advanced Technology Attachment (ATA) adapter, a Serial ATA (SATA) adapter, a Small Computer System Interface (SCSI) adapter, a RAID controller, a SAN adapter, a network adapter, and/or any similarly capable component providing processor 405 with access to storage device 417.

In some embodiments, processor 405 includes one or more modules for performing specific tasks executed by processor 405. For example, processor 405 may include a database management module 430, a tag generating module 432, a communication module 434, and/or a rule building module 436.

In some embodiments, database management module 430 may be configured, for example, to retrieve, from the rules database, a plurality of rules, each of the plurality of rules including one or more data elements that generate an output value based on an input value; to store the generated tags in the rules database in association with the plurality of rules; to store the built modified rule in the rules database; to parse the rules database to identify related rules based on the one or more tags associated with the target rule; to store the built at least one modified related rule in the rules database; to retrieve, in response to the request, the target rule from the rules database; to flag the target rule in the rules database as checked out in response to transmitting the target rule; and/or to flag the target rule in the rules database as checked in in response to receiving the proposed modification of the target rule.

In some embodiments, tag generating module 432 may be configured, for example, to generate, for each of the plurality of rules, one or more tags based on the one or more data elements.

In some embodiments, communication module 434 may be configured, for example, to receive, from a first user computing device, a proposed modification for a target rule of the plurality of rules; cause to be displayed, on the first user computing device, the identified related rules; causing to be displayed, on a second user computing device, at least one of the proposed modification and the suggested modification; to receive a request to modify the target rule from the first user computing device; and/or to transmit the retrieved target rule to the first user computing device.

In some embodiments, rule building module 436 may be configured, for example, to build a modified rule based on the proposed modification; to generate, for at least some of the related rules, a suggested modification based on the proposed modification; and/or to automatically build at least one modified related rule based on the generated suggested modification using at least one of machine learning techniques and artificial intelligence techniques.

Memory area 410 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

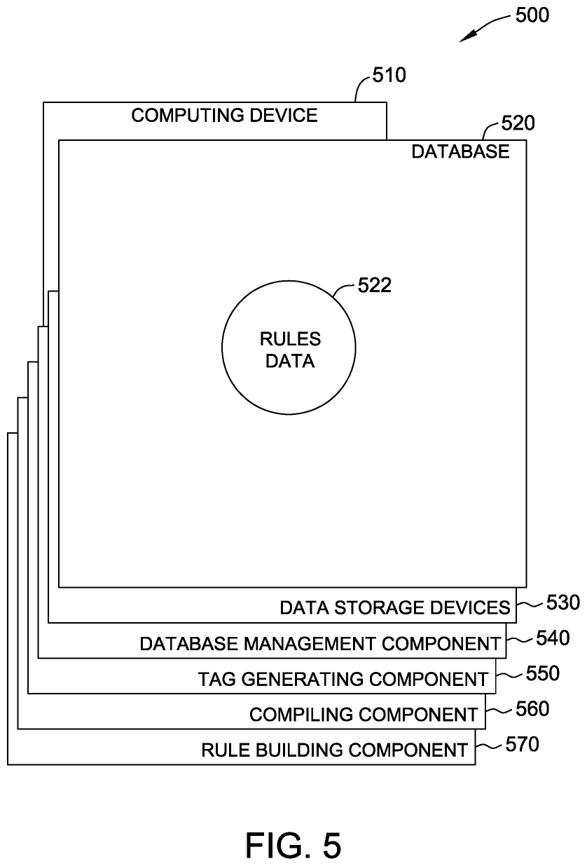

FIG. 5 is a diagram 500 of components of one or more example computing devices 510 that may be used in RM system 100 shown in FIG. 1. In some embodiments, computing device 510 is similar to RM computing device 102 (shown in FIG. 1). Database 520 may be coupled with several separate components within computing device 510, which perform specific tasks. In this embodiment, database 520 includes rules data 522, which may include, for example, rules (e.g., billing rules), rule segments, and pointers, as described above with respect to FIG. 1. In some embodiments, database 520 is similar to database 106 (shown in FIG. 1).

Computing device 510 includes database 520, as well as data storage devices 530 for storing data within database 520. Computing device 510 may also be in communication with one or more of a database management component 540, a tag generating component 550, a communication component 560, and a rule building component 570.

In some embodiments, database management component 540 may be configured, for example, to retrieve, from the rules database, a plurality of rules, each of the plurality of rules including one or more data elements that generate an output value based on an input value; to store the generated tags in the rules database in association with the plurality of rules; to store the built modified rule in the rules database; to parse the rules database to identify related rules based on the one or more tags associated with the target rule; to store the built at least one modified related rule in the rules database; to retrieve, in response to the request, the target rule from the rules database; to flag the target rule in the rules database as checked out in response to transmitting the target rule; and/or to flag the target rule in the rules database as checked in in response to receiving the proposed modification of the target rule.

In some embodiments, tag generating component 550 may be configured, for example, to generate, for each of the plurality of rules, one or more tags based on the one or more data elements.

In some embodiments, communication component 560 may be configured, for example, to receive, from a first user computing device, a proposed modification for a target rule of the plurality of rules; cause to be displayed, on the first user computing device, the identified related rules; causing to be displayed, on a second user computing device, at least one of the proposed modification and the suggested modification; to receive a request to modify the target rule from the first user computing device; and/or to transmit the retrieved target rule to the first user computing device.

In some embodiments, rule building component 570 may be configured, for example, to build a modified rule based on the proposed modification; to generate, for at least some of the related rules, a suggested modification based on the proposed modification; and/or to automatically build at least one modified related rule based on the generated suggested modification using at least one of machine learning techniques and artificial intelligence techniques.

FIGS. 6, 7, and 8 depict a flowchart illustrating an example computer-implemented method 600 for rules management, which may be implemented using RM system 100 (shown in FIG. 1). Computer-implemented method 600 may be implemented by a computing device, for example, RM computing device 102 (shown in FIG. 1), in cooperation with RM system 100.

Computer-implemented method 600 may include retrieving 602, from the rules database, a plurality of rules, each of the plurality of rules including one or more data elements that generate an output value based on an input value. In certain embodiments, retrieving the plurality of rules may be performed by RM computing device 102, for example, by executing database management module 430 (shown in FIG. 4).

Computer-implemented method 600 may further include generating 604, for each of the plurality of rule, one or more tags based on the one or more data elements. In some embodiments, computer-implemented method 600 may include generating 606 the tags based on the plurality of data fields. In certain embodiments, generating 604 the one or more tags may be performed by RM computing device 102, for example, by executing tag generating module 432 (shown in FIG. 4).

Computer-implemented method 600 may further include storing 608 the generated tags in the rules database in association with the plurality of rules. In certain embodiments, storing 608 the one or more tags may be performed by RM computing device 102, for example, by executing database management module 430.

In some embodiments, computer-implemented method may further include storing 610 a plurality of pointers in the rules database, wherein each of the plurality of rules is associated with one of the plurality of pointers. In certain embodiments, storing 610 the plurality of pointers may be performed by RM computing device 102, for example, by executing database management module 430.

Computer-implemented method 600 may further include receiving 612, from a first user computing device, a proposed modification for a target rule of the plurality of rules. In certain embodiments, receiving 612 the proposed modification may be performed by RM computing device 102, for example, by executing communication module 434 (shown in FIG. 4).

In some embodiments, computer-implemented method may further include building 614 a modified rule based on the proposed modification. In certain embodiments, building the modified rule may be performed by RM computing device 102, for example, by executing rule building module 436 (shown in FIG. 4).

In such embodiments, computer-implemented method may further include storing 616 the built modified rule in the rules database. In certain embodiments, storing 616 the modified rule may be performed by RM computing device 102, for example, by executing database management module 430.

Computer-implemented method 600 may further include parsing 618 the rules database to identify related rules based on the one or more tags associated with the target rule. In certain embodiments, parsing 618 the rules database may be performed by RM computing device 102, for example, by executing database management module 430.

Computer-implemented method 600 may further include causing 620 to be displayed, on the first user computing device, the identified related rules. In certain embodiments, causing 620 to be displayed the identified related rules may be performed by RM computing device 102, for example, by executing communication module 434.

In some embodiments, computer-implemented method 600 may further include generating 622, for at least some of the related rules, a suggested modification based on the proposed modification. In certain embodiments, generating 622 the suggested modification may be performed by RM computing device 102, for example, by executing rule building module 436.

In some such embodiments, computer-implemented method 600 may further include causing 624 to be displayed on a second user computing device, at least one of the proposed modification and the suggested modification. In certain embodiments, causing 624 to be displayed the proposed modification or the suggested modification may be performed by RM computing device 102, for example, by executing communication module 434.

In some such embodiments, computer-implemented method 600 may further include automatically building 626 at least one modified related rule based on the generated suggested modification using at least one of machine learning techniques and artificial intelligence techniques. In certain embodiments, automatically building 626 at least one modified related rule may be performed by RM computing device 102, for example, by executing rule building module 436.

In some such embodiments, computer-implemented method 600 may further include storing 628 the built at least one modified related rule in the rules database. In certain embodiments, storing 628 the at least one modified related rule may be performed by RM computing device 102, for example, by executing database management module 430.

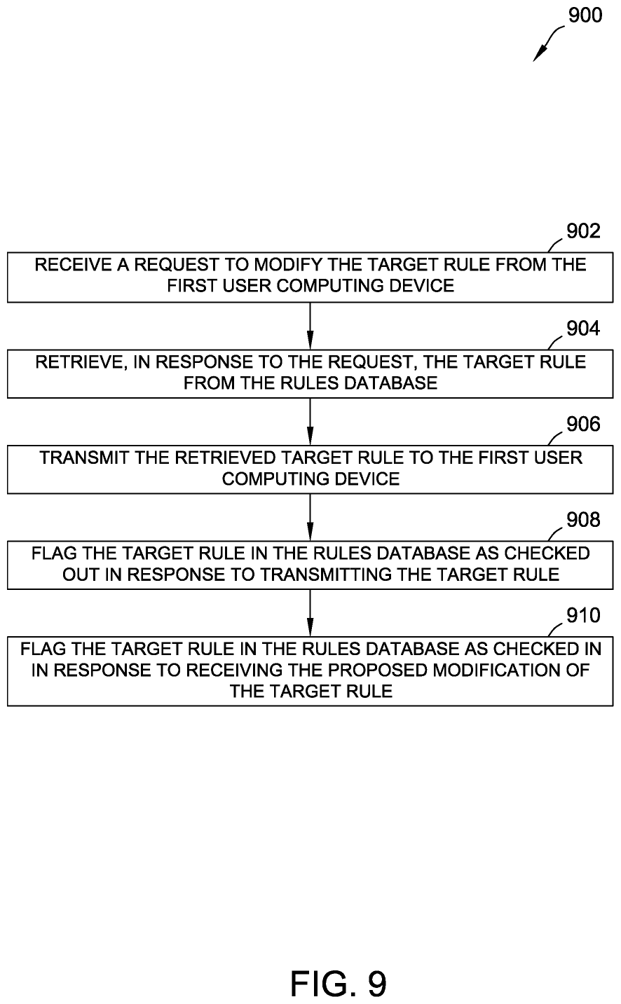

FIG. 9 depicts flowchart illustrating an exemplary computer-implemented method 900 for rules management that may be performed in conjunction with computer-implemented method 600 (shown in FIGS. 6-8), which may be implemented using RM system 100 (shown in FIG. 1). Computer-implemented method 900 may be implemented by a computing device, for example, RM computing device 102 (shown in FIG. 1), in cooperation with RM system 100.

Computer-implemented method 900 may include receiving 902 a request to modify the target rule from the first user computing device. In certain embodiments, receiving 902 the request may be performed by RM computing device 102, for example, by executing communication module 434 (shown in FIG. 4).

Computer-implemented method 900 may further include retrieving 904, in response to the request, the target rule from the rules database. In certain embodiments, retrieving 904 the target rule may be performed by RM computing device 102, for example, by executing database management module 430 (shown in FIG. 4).

Computer-implemented method 900 may further include transmitting 906 the retrieved target rule to the first user computing device. In certain embodiments, transmitting 906 the target rule may be performed by RM computing device 102, for example, by executing communication module 434.

Computer-implemented method 900 may further include flagging 908 the target rule in the rules database as checked out in response to transmitting the target rule. In certain embodiments, flagging 908 the target rule as checked out may be performed by RM computing device 102, for example, by executing database management module 430.

Computer-implemented method 900 may further include flagging 910 the target rule in the rules database as checked in in response to receiving the proposed modification of the target rule. In some embodiments, flagging 910 the target rule as checked in may be performed by RM computing device 102, for example, by executing database management module 430.

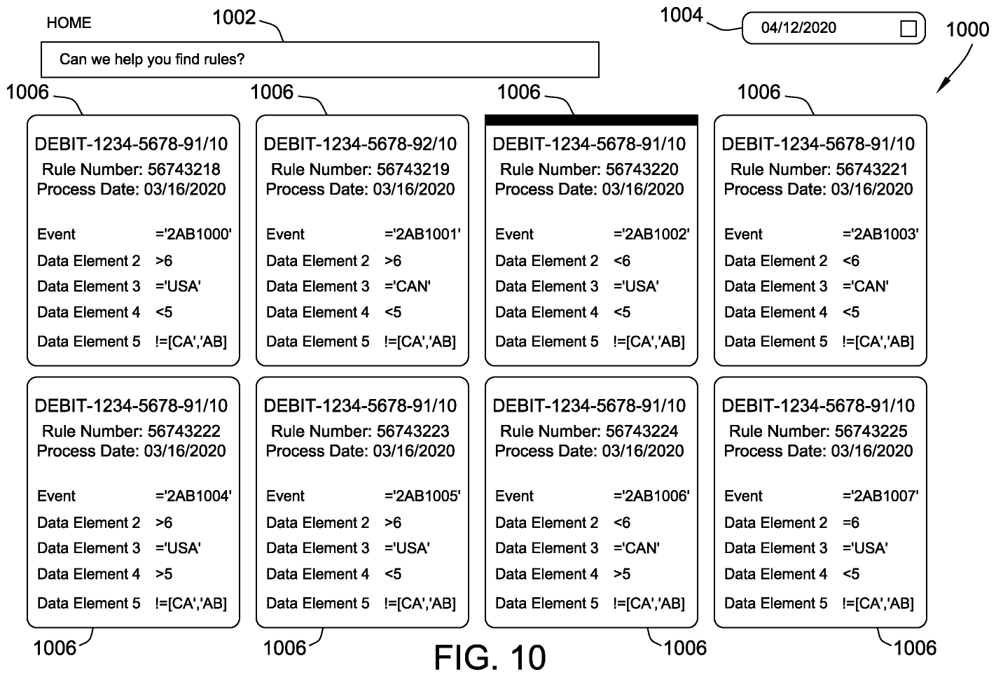

FIGS. 10-12 depict example screenshots of an example user interface for rules management that may be used in rules management system 100 (shown in FIG. 1). In particular, FIG. 10 depicts an example dashboard interface 1000 of the user interface. Dashboard interface 1000 is displayed by user computing device 108 in response to instructions received from RM computing device 102. Dashboard interface 1000 may include a search bar 1002, into which a user may enter search terms (e.g., a pointer, a rule identifier, or data elements), in response to which RM computing device 102 may perform a search in rules database 106 (as described with respect to FIG. 1). Dashboard interface 1000 may further include an effective date field 1004, which may indicate a current value and/or be used to specify a new value for an effective date for the entered search, such that the search results correspond to the selected effective date. Dashboard interface further includes search results 1006, represented in FIG. 10 as individual display subareas or “cards,” each of which may represent a rule that is included in the search results. Each search result 1006 may include information about the corresponding rule such as, for example, a pointer, a rule identifier, and data elements of the rule. While FIG. 10 depicts search results 1006 as being represented by cards, in some embodiments, dashboard interface 1000 may further include search results 1006 displayed as, for example, a list or hierarchy, in addition or as an alternative to the card-type display. For example, a user may be able to select between having search results 1006 displayed as cards or as a list. In some embodiments, in response to selecting one of search results 1006 (e.g., by clicking on or hovering a cursor over the card), additional information about the corresponding rule may be displayed. For example, the card may “flip over” to reveal more information on a reverse side of the card. In some embodiments, the search results may further display, for each rule, a list of input data (e.g., transactions) associated with the selected rule (e.g., transactions that may trigger the selected rule).

In some embodiments, each search result 1006 may include one or more data elements associated with the corresponding rule. These data elements may be used by, for example, data processing network 110 to determine that a certain rule (e.g., a billing rule) should be applied to certain input data (e.g., a transaction). For example, a data element that specifies that a transaction must occur in a particular region such as the United States (e.g., “Data Element 3=‘USA’”) causes a billing rule including the data element (e.g., “Rule Number: 56743218,” shown as the top left search result 1006) to be applied only to transactions that occurred in the United States.

In some embodiments, dashboard interface 1000 may further display additional data, such as a list of frequently checked-out rules (e.g., five most frequently checked-out rules), recently checked-out rules (e.g., five most frequently checked-out rules), or a list of currently checked out rules of the user. The checked out rules may be, for example, rules currently being drafted or edited by the user or other users, that are undergoing review and/or awaiting approval. The list of work-in-progress rules may include an indicator of which user is currently working on the rule and/or a status of the rule (e.g., in draft, under review, approved, etc.).

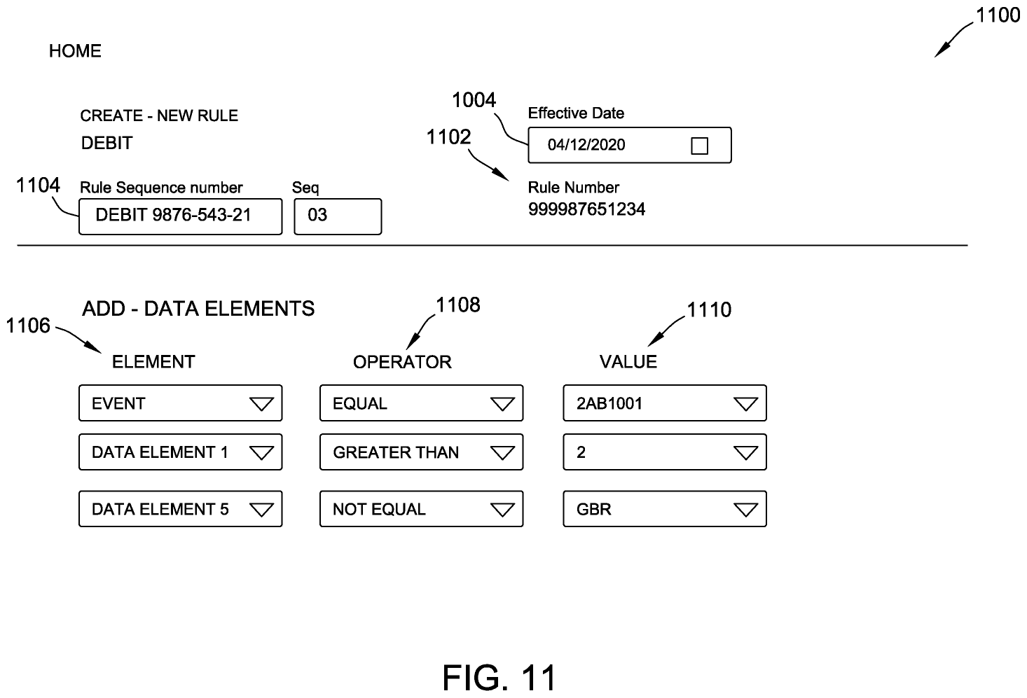

FIG. 11 depicts an example rule editing interface 1100 of the user interface. Rule editing interface 1100 may be displayed by user computing device 108 in response to instructions received from RM computing device 102, for example, in response to the user selecting a search result 1006 or other rule via dashboard interface 1000. Rule editing interface 1100 may enable the user to create a rule from scratch, clone an existing rule, edit or delete a rule, and to preview changes to rules. Rule editing interface 1100 may include effective date field 1004 as described above. Rule editing interface 1100 may further include a rule number field 1102, which may indicate, for example, the rule identifier corresponding to the selected rule. Rule editing interface 1100 may further include a rule sequence number field 1104, which may be used to select a portion of the selected rule (e.g., having a particular rule segment identifier) to be edited. Rule editing interface 1100 may further include a data element field 1106, which may be used to select data elements of the selected rule to edit, add, or delete. Rule editing interface 1100 may further include an operator field 1108 and a value field 1110, through which the user may select and edit an operator and a value corresponding to each data element. Accordingly, the user may, for example, adjust the set of inputs (e.g., transactions) to which the rule is applied and/or adjust the output value (e.g., invoice amount) generated by the rule for a given input value (e.g., transaction data).

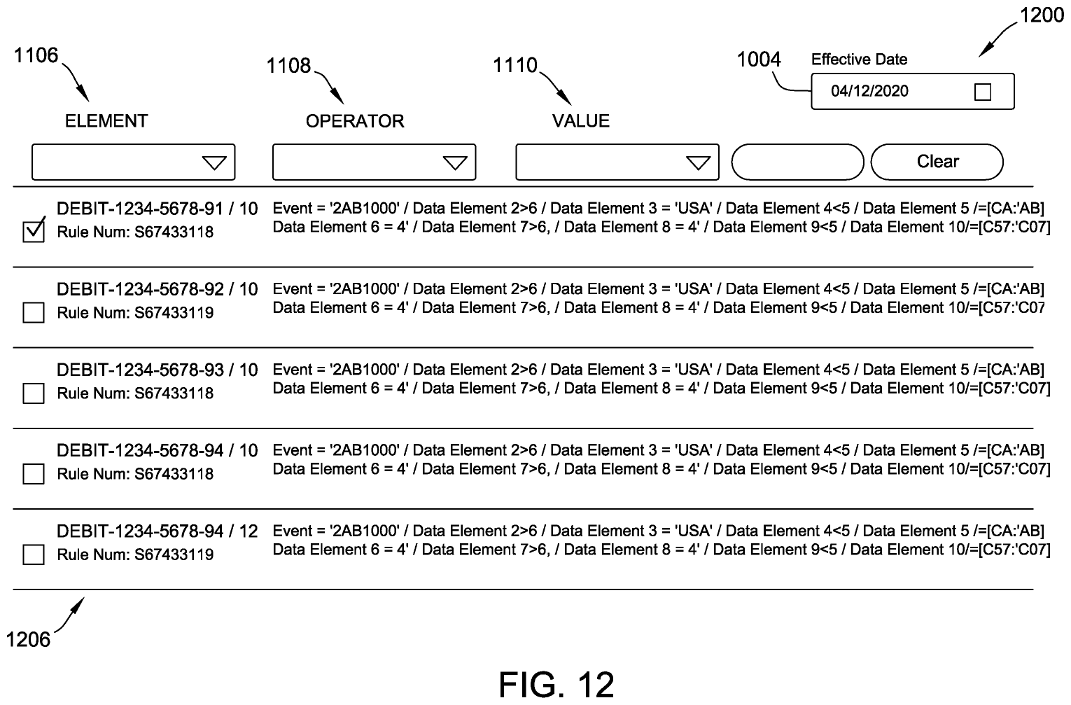

FIG. 12 depicts an example rule management interface 1200 of the user interface. Rule management interface 1200 may be displayed by user computing device 108 in response to instructions received from RM computing device 102, for example, in response to submitting changes to a rule using rule editing interface 1100, and may display related rules based on the selected rule (as described with respect to FIG. 1). Like rule editing interface 1100, rule management interface 1200 may include effective date field 1004, data element field 1106, operator field 1108, and value field 1110. Rule management interface 1200 may further include a list 1206 of related rules. List 1206 may include suggested modifications to the related rules (as described with respect to FIG. 1). The user may select related rules from list 1206, for example, to modify or delete according to the suggested modifications. In some embodiments, list 1206 may include additional information, such as input data (e.g., transactions) associated with the related rules (e.g., transactions that may trigger the modified related rules).

In the systems and methods described herein, a processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based on example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based on the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based on these analyses, the processing element may learn how to identify characteristics and patterns that may then be applied to training models, analyzing transaction and authentication data, and detecting and analyzing risk.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a system that automatically generates and tracks tasks to be performed by a patient. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the RM computing device are described herein as including general processing and memory devices, it should be understood that the RM computing device is a specialized computer configured to perform the steps described herein.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A rules management (RM) computing device comprising at least one processor in communication with at least one memory device and a rules database, the at least one processor configured to:
retrieve, from the rules database, a plurality of rules, each of the plurality of rules including one or more data elements that generate an output value based on an input value;
generate, for each of the plurality of rules, one or more tags based on the one or more data elements;
store the generated tags in the rules database in association with the plurality of rules;
receive, from a first user computing device, a proposed modification for a target rule of the plurality of rules;
parse the rules database to identify related rules based on the one or more tags associated with the target rule; and
cause to be displayed, on the first user computing device the identified related rules.

2. The RM system of claim 1, wherein the at least one processor is further configured to:
build a modified rule based on the proposed modification; and
store the built modified rule in the rules database.

3. The RM system of claim 1, wherein the at least one processor is further configured to generate, for at least some of the related rules, a suggested modification based on the proposed modification.

4. The RM system of claim 3, wherein the at least one processor is further configured to cause to be displayed, on a second user computing device, at least one of the proposed modification and the suggested modification.

5. The RM system of claim 3, wherein the at least one processor is further configured to:
automatically build at least one modified related rule based on the generated suggested modification using at least one of machine learning techniques and artificial intelligence techniques; and
store the built at least one modified related rule in the rules database.

6. The RM system of claim 1, wherein each input value includes a plurality of data fields.

7. The RM system of claim 6, wherein to generate the tags, the at least one processor is configured to generate the tags based on the plurality of data fields.

8. The RM system of claim 1, wherein each of the plurality of rules corresponds to a billing rule and the input values correspond to billing events.

9. The RM system of claim 1, wherein the at least one processor is further configured to store a plurality of pointers in the rules database, wherein each of the plurality of rules is associated with one of the plurality of pointers.

10. The RM system of claim 1, wherein the at least one processor is further configured to:
receive a request to modify the target rule from the first user computing device,
retrieve, in response to the request, the target rule from the rules database;
transmit the retrieved target rule to the first user computing device;
flag the target rule in the rules database as checked out in response to transmitting the target rule; and
flag the target rule in the rules database as checked in in response to receiving the proposed modification of the target rule.

11. A computer-implemented method for rules management performed by a rules management (RM) computing device including at least one processor in communication with at least one memory device and a rules database, the computer-implemented method comprising:
retrieving, by the RM computing device, from the rules database, a plurality of rules, each of the plurality of rules including one or more data elements that generate an output value based on an input value;
generating, by the RM computing device, for each of the plurality of rules, one or more tags based on the one or more data elements;
storing, by the RM computing device, the generated tags in the rules database in association with the plurality of rules;
receiving, by the RM computing device, from a first user computing device, a proposed modification for a target rule of the plurality of rules;
parsing, by the RM computing device, the rules database to identify related rules based on the one or more tags associated with the target rule; and
causing, by the RM computing device, to be displayed, on the first user computing device, the identified related rules.

12. The computer-implemented method of claim 11, further comprising:
building, by the RM computing device, a modified rule based on the proposed modification; and
storing, by the RM computing device, the built modified rule in the rules database.

13. The computer-implemented method of claim 11, further comprising generating, by the RM computing device, for at least some of the related rules, a suggested modification based on the proposed modification.

14. The computer-implemented method of claim 13, further comprising causing, by the RM computing device, to be displayed, on a second user computing device, at least one of the proposed modification and the suggested modification.

15. The computer-implemented method of claim 13, further comprising:
automatically building, by the RM computing device, at least one modified related rule based on the generated suggested modification using at least one of machine learning techniques and artificial intelligence techniques; and
storing, by the RM computing device, the built at least one modified related rule in the rules database.

16. The computer-implemented method of claim 11, wherein each input value includes a plurality of data fields.

17. The computer-implemented method of claim 16, wherein generating the tags comprises generating, by the RM computing device, the tags based on the plurality of data fields.

18. The computer-implemented method of claim 11, wherein each of the plurality of rules corresponds to a billing rule and the input values correspond to billing events.

19. The computer-implemented method of claim 11, further comprising storing, by the RM computing device a plurality of pointers in the rules database, wherein each of the plurality of rules is associated with one of the plurality of pointers.

20. At least non-transitory computer-readable media having computer-executable instructions embodied thereon, wherein when executed by a rules management (RM) computing device including at least one processor in communication with at least one memory device and a rules database, cause the at least one processor to:
retrieve, from the rules database, a plurality of rules, each of the plurality of rules including one or more data elements that generate an output value based on an input value;
generate, for each of the plurality of rules, one or more tags based on the one or more data elements;
store the generated tags in the rules database in association with the plurality of rules;
receive, from a first user computing device, a proposed modification for a target rule of the plurality of rules;
parse the rules database to identify related rules based on the one or more tags associated with the target rule; and
causing to be displayed, on the first user computing device the identified related rules.
